(19) United States
(12) Patent Application Publication
(10) Pub. No.: US 2007/0136426 A1
(43) Pub. Date: Jun. 14, 2007

(54) Process of Decentralized Distribution of E-mail Messages

(76) Inventors: Matthew Tate Smith, Davenport, IA (US); Ian Spencer Brown, Le Claire, IA (US)

Correspondence Address: JEFFREY FURR, 253 N. MAIN STREET, JOHNSTOWN, OH, 43031, US

(21) Appl. No.: 11/164,913

(22) Filed: Dec. 10, 2005

(51) Int. Cl. G06F 15/16

(52) U.S. Cl. 709/206

(57) ABSTRACT

A process of decentralizing distribution of electronic mail messages. The goal of this invention is to decentralize the distribution of email messages for the purpose of decreasing the number of messages sent through a single IP address. This will decrease the percentage of messages which are filtered out as spam due to the IP address of the sending SMTP. This concept applies to any corporation which sends out marketing messages on behalf of its members.

### BACKGROUND

1. Field of the Invention

This invention relates generally to electronic mail systems and more particularly to the process of decentralizing distribution of electronic mail messages.

2. Description of Prior Art

Electronic mail is an increasingly popular form of communication and almost mission critical to many businesses. Electronic mail systems allow a sender who is one Member of a computer system to send an electronic message to another Member who is a recipient. The sender designates the recipient to whom the electronic mail is to be sent and creates the body of the electronic mail message. The electronic mail system then forwards the electronic mail message to the recipient via a communications mechanism such as a local area network or the Internet. When the recipient receives the electronic mail messages, the recipient can view the body of the electronic mail message.

With the increasing popularity of the Internet and the global workplace, a Member may be able to send electronic mail messages to anyone who is connected to the Internet. The sender of an electronic mail message needs only to know the electronic mail address of the recipient. Thus, Members can and often do receive electronic mail messages from unknown senders. Because of the perceived benefits of advertising via the Internet on the low costs of doing so, many companies are using electronic mail messages as a way to get messages to their clients. These companies acquire and maintain lists of electronic mail addresses for thousands of customers. When a client wants to advertise a product, the promotional company will send an electronic mail message to each electronic mail address in its list.

The sending out of these E-mails can overwhelm a single electronic mail server and sometimes the sender can be placed on a spam ban list.

### PRIOR ART

U.S. Pat. No. 6,907,418 by Shin, et al. and issued on Jun. 14, 2005, is for an advertisement servicing system using e-mail arrival notifying program and method. It discloses an advertisement servicing system using an e-mail arrival notifying program.

U.S. Pat. No. 6,829,333 by Frazier and issued on Dec. 7, 2004, is for an automated system for messaging based on chains of relationships. It discloses a computer system for automatically generating and sending messages to individuals, entities, processes, or locations (objects) in response to events when specified conditions are met.

U.S. Pat. No. 6,578,010 by Teacherson and issued on Jun. 10, 2003, is for a multi-node network marketing computer system. It discloses a method, process and means for accomplishing multiple, independent funds raising by multiple, independent entities, each of the entities under their own names, all under one “umbrella” system, having a limited-population subset system, all with the added and crucial benefit of a novel process, and system therefor, for safekeeping entity funding flow while safekeeping and preventing loss of funds by individuals.

U.S. Pat. No. 6,377,936 by Henrick, et al. and issued on Apr. 23, 2002, is for a method for performing targeted marketing over a large computer network. It discloses a method for enabling targeted marketing of Members on the Internet maintains the privacy of the Members. The present invention takes advantage of the unique customer knowledge of an Internet Service Provider (ISP) with respect to both the customers identity and their likes and dislikes, while preserving the privacy of those customers.

U.S. Pat. No. 6,101,485 by Fortenberry, et al. and issued on Aug. 8, 2000, is for electronic solicitations for internet commerce. It discloses a method for engaging in electronic commerce over the Internet, comprising the steps of: programming a first electronic mail (e-mail) message to include: a description of at least one product available for sale by an electronic commerce (e-commerce) site; a shopper selectable indicia for indicating that the shopper has chosen to purchase the at least one product; and, a shopper activatable link back to the e-commerce site for transmitting a second e-mail message including the shopper's choice to purchase the at least one product; transmitting the e-mail message over the Internet to at least one potential shopper; and, in response to receiving the second e-mail message transmitted back to the e-commerce site by activation of the link by the at least one potential shopper, consummating the purchase of the at least one product by the at least one potential shopper.

U.S. Pat. No. 5,555,346 by Gross, et al. and issued on Sep. 10, 1996, is for an event-driven rule-based messaging system. It discloses a flexible, event driven and conditional rule based mail messaging system which can be transparently implemented for use in electronic mail applications.

United States Patent Application 20050058263 by Frazier and published on Mar. 17, 2005, is for an automated system for messaging based on chains of relationships. It discloses a computer system for automatically generating and sending messages to individuals, entities, processes, or locations (objects) in response to events when specified conditions are met.

United States Patent Application 20050049953 by Vu and published on Mar. 3, 2005, is for a real estate business method and system integrating multi-level network marketing, franchise management and web tools. It discloses a real estate business method and system integrating multi-level network marketing, franchise management and web tools provides an opportunity for members of the general public to receive training in and assist in negotiating and transacting contracts for the sale of real estate. A

United States Patent Application 20030037114 by Nishio, et al. and published on Feb. 20, 2003, is for a system, method and apparatus for updating electronic mail recipient lists. It discloses an e-mail system that includes a responsible person terminal holding a plurality of recipient addresses to which given e-mail is sent, and a reference list editor terminal connected to the responsible person terminal through a network for editing a reference list consisting of one or more recipient addresses to be updated from among the recipient addresses.

The need for a better method for sending out a large number of electronic messages that is accurate, quick, inexpensive, and easy to use shows that there is still room for improvement within the art.

### SUMMARY OF THE INVENTION

The object of the present invention is to provide a process of decentralizing distribution of electronic mail messages. The goal of this invention is to decentralize the distribution of email messages for the purpose of decreasing the number of messages sent through a single IP address. This will decrease the percentage of messages which are filtered out as spam due to the IP address of the sending SMTP. This concept applies to any corporation which sends out marketing messages on behalf of its members. An example would be Amway or Mary Kay.

The process is more efficient, effective, and functional than the current art.

### GLOSSARY OF TERMS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its

raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a Member sends and receives E-mail;

FIG. 2 shows a sample of a how multiple E-mail messages are sent;

FIG. 3 the gateway server of the system; and

FIG. 4 shows the major components of the system.

### DESCRIPTION OF THE PREFERRED EMBODIMENT

Below is the preferred embodiment of the current invention, but it is not the only embodiment of the current invention and should not be read as such.

Electronic mail is an increasingly popular form of communications. Electronic mail systems allow one sender a Member of a computer system to send a message electronically to another Member, a recipient. To create an electronic mail message, the sender designates the recipient to whom the electronic mail is to be sent and creates the body of the electronic mail message. The electronic mail system then forwards the electronic mail message to the recipient via a communications mechanism like a local area network or the Internet.

The System 1 is a computer system and method for decentralizing the distribution of email messages for the purpose of decreasing the number of messages sent through a single IP address. This will decrease the percentage of messages which are filtered out as spam due to the IP address of the sending SMTP. This concept applies to any corporation which sends out marketing messages on behalf of its members. An example would be Amway or Mary Kay. When a company sends out too many E-mail from the same IP address sometimes that IP address will be added to a SPAM block list of IP addresses by Anti-Spam programs even if the E-mail are not SPAM but requested information to clients and customers.

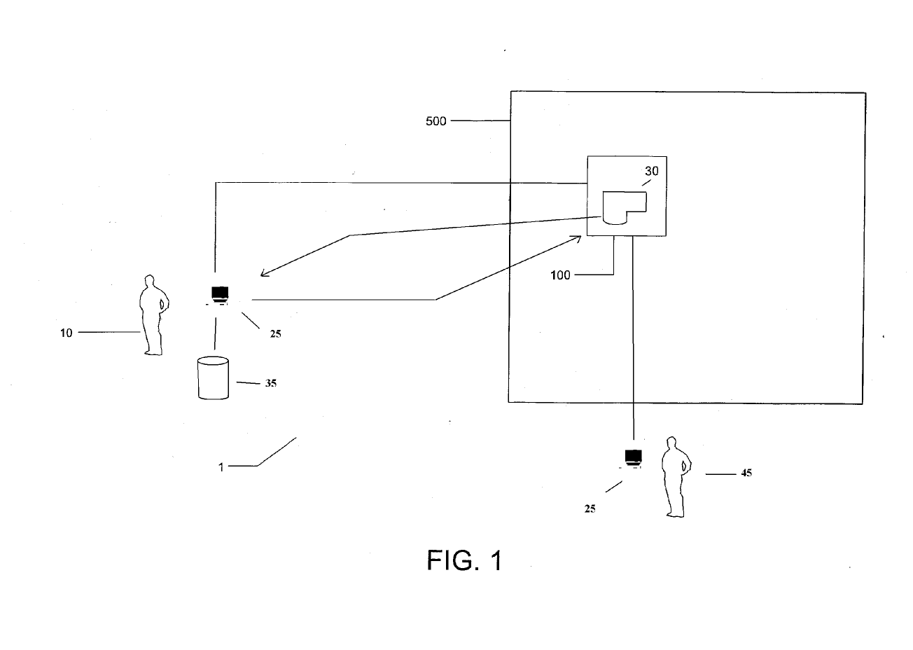

FIG. 1 illustrates a functional diagram of how a Member 10 sends and receives E-mail 75 from a computer 25 connected to the Internet 500. The computer 25 can be connected directly through a communication means such as a local Internet Service Provider, often referred to as ISPs, or through an on-line service provider like CompuServe, Prodigy, American Online, etc.

The Members 10 contacts the Internet 500 using an informational processing system capable of running an HTML compliant Web browser such as Microsoft's Internet Explorer, Netscape Navigator, Lynx, and Mosaic. A typical system that is used is a personal computer with an operating system such as a Windows variant or Linux or Mac OS, running a Web browser. The exact hardware configuration of computer used by the Member 10, the brand of operating system, or the brand of Web browser configuration is unimportant to understand this present invention. Those skilled in the art can conclude that any HTML (Hyper Text Markup Language) compatible Web browser is within the true spirit of this invention and the scope of the claims.

Currently, the Member 10 connects to the Internet 500. The Member 10 creates E-Mail messages 30 using a standard E-mail system 35 such as AOL, Microsoft Outlook, or Hotmail. Once created the Member 10 hits the send or completed key. The E-mail system 35 sends the E-Mail messages 30 through the Internet 500 to the E-Mail Server 100 where it is redirected to the receiver 40. The E-mail server 100 handles thousands and thousands of such requests. Sender 45 uses the same previously mentioned method to send an E-Mail 30 to the Member 10. The Member's 10 system 35 tells the Member 10 that he/she has an E-mail message 30 waiting for him/her.

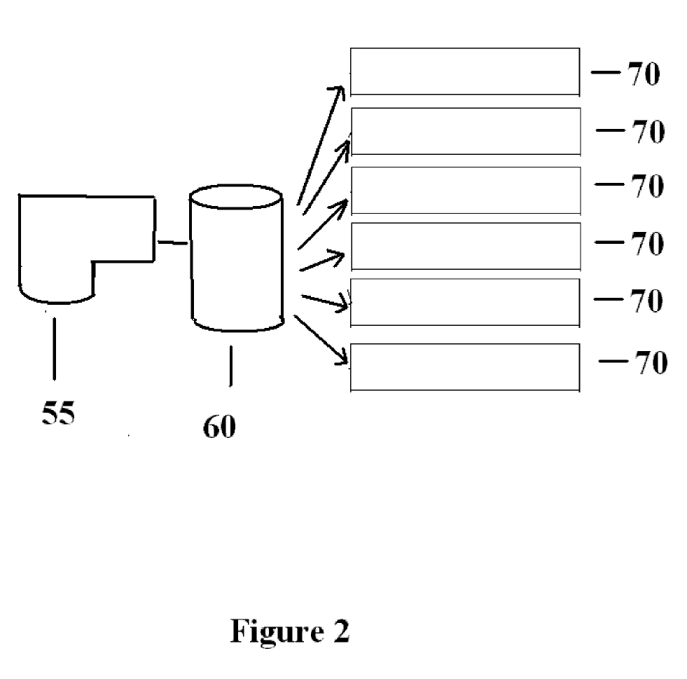

As shown in FIG. 2, many companies that send on a large volume of Electronic Messages will do if from a single mail server using that servers IP address. These bulk Electronic Messages or E-mails 70 are sent out by computer systems 55 that are written to send out E-mails in bulk to customers who E-mail address is in a customer database 60.

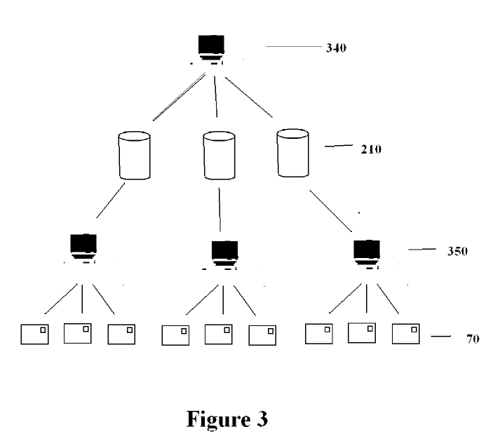

The current invention is display in FIG. 3 consisting of a Gateway server 340 distributes parts of the bulk E-mails 70 to a plurality of decentralized servers 350 each with its own IP address. These decentralized mail servers 350 will send out a portion of the E-mails to the customers. These decentralized mail servers can be any PC computer from a home computer up to a server. Any computer can be used to send out messages.

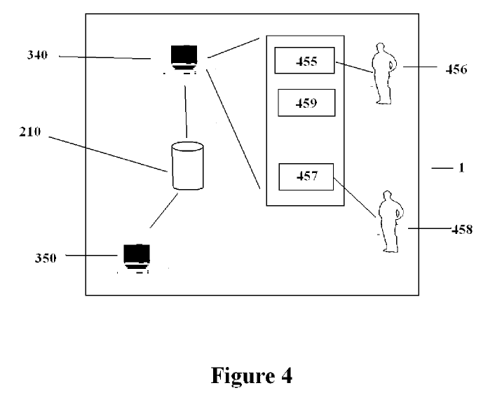

As shown in FIG. 4, the system 1 has a Client Application 110 for sending packages 210. A Member 10 will install the application unto their computer, they will initialize their connection settings, and they will import SMTP settings from Outlook Express/MS Outlook.

The Member 10 will connect to the Gateway Server 340 using the client application, while connected the application will check for version updates, receive package to be sent, store the package 210 locally, and get a message content from the Gateway Server 340.

The Member 10 will send a message with merged fields, check sending results, send all messages in the package 210 and confirm the sending of a package 210.

The Gateway Server 340 performs member authentication. When a member 10 signs on the Gateway Server 340 the system 1 shows the authentication form. It validates the deal, Membername and password. It redirect to Member's area according to the role that they are doing for the electronic communication.

The system 1 will have a system administration area 455. This area will be accessed by the system administrator 456. This area will manage the deals, which are the electronic batch mailing. The system administration will use this area to create/edit a new deal. This is done by entering a name of the Deal, enter Deal Administrator Membername and Password, and upload Client app for the deal,

The system administrator 456 and enter POP3 Email account Settings (used for automatic registering of new members via email).

Sample format of the registration email:

<--

CustomerID: 29232

Fname: Joe

Lname: Bloe

Address: 101 Main Street

City: Littleton

State: CO

Zip: 80120

Phone: (303) 749-0523

Member:kenn@somedomain.com

Pass: 29232

Email: kenn@somedomain.com

Country: USA

Company: Your Company

-->

The system administration area 455 will enter and send out welcome e-mail message content for new members (used for automatic registering of new members via email).

The system admistrator 456 can also delete a Deal. The system admistrator 456 will edit a deal and check the “Is Active” box off, and save it, then click on the Delete button and confirm.

The system admistrator will also be able to check download links for deals.

The system 1 will also have a deal administrator area 457 for the Deal Administrator 458, This area is used to Manage Members, create/Edit a new member and import New Members/Update info from CSV file.

A Sample format of the CSV file:

FirstName,LastName,Email,Login,Password,IsActive,CustomerID,Address,City,State,Zip,Phone,Country,Company

John,Smith,jsmith@blabla.com,j_smith,pass,true,15432,BlaBla St 20,Washington,DC,11000,+12224448855,USA,Itimemarketing com.

Matthew,Kennedy,mkennedy@foobar.com,m_kennedy,mypass,false,,,,,,,,

The deal administration area 457 will be used by the deal administrator 458 to filter the Member List, delete a member or members and to view a member's activity.

The area will also be used to manage Contact Groups which are groups of members. It will allow the administrator to create and/or Edit a group, delete a group (not system only) and manage the Contacts In Group.

The deal administration area will also manage Contacts, which can be group contacts or individual members 20. It will allow an administrator to create/Edit a new contact, and to Import New Contacts/Update info from CSV file.

Sample format of the CSV file:

Email,FirstName,LastName,Address,City,State,Zip,DOB,Gender

jsmith@blabla.comjohn,Smith,BlaBla St 20,Washington,DC,11000,09/13/1977,Male

mkennedy@foobar.com,Matthew,Kennedy,,,,,,

It will allow the administrator to delete a contact, and to import Opt-out Contacts from CSV file.

Sample format of the CSV file:

Email

jsmith@blabla.com

mkennedy@foobar.com

It will also allow an administrator to filter a Contact List.

The deal administration area will allow the administrator to manage Email Series which is a set of E-Mail messages by creating a new email series by entering the Series Information, add a message(s) to a series (finish adding messages by clicking on the “Save & Proceed to groups”, define “Send To” groups, edit Email Messages in Series, create/Edit a message, set up the order of messages and delete a message if need be.

It will distribute On-Going Email Series and distribute/Redistribute One-Time Message. It will refresh Series Statuses and filter Email Series List,

The system 1 will produce and allow for viewing a print out a View Activity Report, a view Log List and a filter log list.

The system 1 will have a member's area 459. In this area the member 10 will manage their contacts by creating and/or editing a new contact, importing New Contacts/Update info from CSV file.

Sample format of the CSV file:

Email,FirstName,LastName,Address,City,State,Zip,DOB,Gender

jsmith@blabla.com,John,Smith,BlaBla St 20, Washington, D.C., 11000,09/13/1977,Male

mkennedy@foobar.com,Matthew,Kennedy,,,,,,

The member 10 will be able to delete a contact and import Opt-out Contacts from CSV file.

Sample format of the CSV file:

Email

jsmith@blabla.com

mkennedy@foobar.com

The member will be able to Filter Contact Lists.

The member will be able to manage Own Email Series if they want to send out an E-mail series, create a new own email series by entering Series Information and adding a message(s) to a series (finish adding messages by clicking on the “Save & Proceed to groups”). A member will be able to define “Send To” groups, edit Email Messages in Series, create and/or Edit a message, set up the order of messages and delete a message.

A member 10 through the system 1 will be able to distribute their own On-Going Email Series, distribute/Redistribute their own One-Time Message, refresh Series Statuses and filter their Email Series List.

A member will be able to download Client information for the Deal (in the Download section) and export and download their own contacts to a CSV file.

The System 1 will process errors, distribute packages between active clients, prepare series of messages, send new package to the client application, send version update to the client, log member activity, register new member via Email (for each deal in the system), check POP3 account for new messages (registration emails), download messages, parse registration messages and register new members. In the preferred embodiment, there will be many means of adding members such as—manually, by email and by web service.

In the preferred embodiment, the program and its routines will be written in C++ language, however, the program can be written in any standard programming language.

### ALTERNATIVE EMBODIMENTS

In an alternative embodiment, the System 1 could also be used in a Wireless cell phone environment.

### ADVANTAGES

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for sending out E-mail messages comprising;
having a gateway server distribute the E-mail messages out to other mail servers for distribution.

2. A system according to claim 1 wherein said mail servers is a server.

3. A system according to claim 1 wherein said mail servers is a personnel computer.

4. A system according to claim 1 wherein said system has a client application for the sending of E-mails.

5. A system according to claim 1 wherein a member will connect to the gateway server receive the addresses to which the E-mail is to be sent, store the package on the mail server and get the message and send all of the E-mail messages.

6. A system according to claim 1 wherein said system has a system administration area.

7. A system according to claim 6 wherein said system administration area is accessed by a system administrator.

8. A system according to claim 6 wherein said system administration area is used to create a deal.

9. A system according to claim 6 wherein said system administration area is used to modify a deal.

10. A system according to claim 1 wherein said system has a deal administrator area.

11. A system according to claim 10 wherein said deal administrator area is accessed by a deal administrator.

12. A system according to claim 10 wherein said deal administrator area manages members.

13. A system according to claim 1 wherein said system has a members area.

14. A system for sending out E-mail messages comprising; a Gateway server that distributes parts of bulk E-mails to a plurality of decentralized servers each with its own IP address, said decentralized servers sends out a portion of the E-mails to the customers.

15. A system according to claim 14 wherein said decentralized servers is a server.

16. A system according to claim 14 wherein said decentralized is a personnel computer.

17. A system according to claim 14 wherein said system has a client application for the sending of E-mails has a system administration area where said system administration area is used to create a deal and used to modify a deal, has a deal administrator area where said deal administrator area manages members; and has a members area.

18. A system according to claim 14 wherein a member will connect to the gateway server receive the addresses to which the E-mail is to be sent, store the package on the mail server and get the message and send all of the E-mail messages.

19. A system according to claim 14 wherein a member will manage their own Email Series, send out an E-mail series, create a new own email series, define “Send To” groups, edit Email Messages in Series, create and/or Edit a message, set up the order of messages and delete a message.

20. A system according to claim 14 wherein the System will process errors, distribute packages between active clients, prepare series of messages, send new package to the client application, send version update to the client, log member activity, register new member via Email, check for new messages, download messages, parse registration messages and register new members.
